(19) United States
(12) Patent Application Publication
(10) Pub. No.: US 2005/0171910 A1
(43) Pub. Date: Aug. 4, 2005

(54) Method for integrating enterprise collaborative operations in product lifecycle management and system thereof

(76) Inventors: Chuan-Yu Wu, Taipei City (TW); Chao-Hung Wang, Taipei City (TW); Sung-Ping Cheng, Tai Chung Hsien (TW); Der-Lind Duh, Hsin Chu City (TW); Chii-Yah Yuan, Hsin Chu City (TW); Jen-Yau Kuo, Hsin Chu City (TW)

Correspondence Address: RABIN & BERDO, P.C.;Suite 500, 1104 14 Street, N.W., Washington, DC, 20005, US

(21) Appl. No.: 10/768,042

(22) Filed: Feb. 2, 2004

(51) Int. Cl. G06F 17/60

(52) U.S. Cl. 705/50

(57) ABSTRACT

A method for integrating enterprise collaborative operations in the product lifecycle management (PLM) and a system thereof are proposed. The system comprises at least a message server, at least a web server, a system engineering service platform server, at least a PLM application system server and an enterprise portal server. The system can build a system integration environment between customers, central manufacturers, and providers and offer a collaborative platform between enterprises. Information can thus be interchanged in real time in this system integration environment in the whole PLM from idea through specification requirement, design, development, manufacturing to termination, thereby providing a system integration method and environment for collaborative management, development, manufacturing and marketing between enterprises, providers and customers.

### FIELD OF THE INVENTION

The present invention relates to a method for integrating enterprise collaborative operations in the product lifecycle management (PLM) and a system thereof and, more particularly, to a system integration method between the enterprises, customers and providers in the PLM from idea to termination for building a collaborative operating environment and shortening the operating time of each phase.

### BACKGROUND OF THE INVENTION

From the commercial standpoint, today's enterprises face challenges like how to enhance the relationship with customers, how to achieve the optimum operating performance, how to provide leading-edge products and so on.

In order to enhance the relationship with customers, it is necessary to understand and fast respond to the requirements of existent and potential customers and build valid relations and provide consistent and longtime value to customers.

In order to achieve the optimum operating performance, an enterprise needs to enhance the efficiency of internal operations and external operations with cooperative partners and provide high-quality products meeting the requirement and having the lowest cost for customers. In order to provide leading-edge products, an enterprise needs to provide products most meeting the requirement of customers and also best services for customers.

Today's enterprise system usually forms a satellite system between the central manufacturer and providers. In the challenging global markets, the whole system commonly faces global customers and competitors and needs to rely on innovative and collaborative cooperation for survival. An enterprise needs to confront problems in product, procedure, organization and so on for the innovative and collaborative operation in business to improve competition capability and performance. An enterprise ought to preserve, manage, exploit intelligence of resources of itself and with cooperative partners, and face pressures and competitions in the market with the most flexible and agilest collaborative mode.

In order to accomplish the objective of collaborative operations between enterprises, it is necessary to rely on the information technology in full business mode. As shown in FIG. 1, a today's enterprise uses separate management information systems (MIS) like development 101, production 102, marketing 103 and son on for different demands like, customer relationship management (CRM) 104, product development management (PDM) 105, enterprise resource planning (ERP) management 106, supply chain management (SCM) 107 and so on.

Integration between system and system includes the integration inside enterprise and the integrations of business to business (B2B) and business to customer (B2C). The conventional time-consuming and error-susceptive way of communication via telephone, fax, email is gradually replaced by electronic data interchange (EDI) for system integration. Existent relevant techniques for data interchange like Rosetta Net, cXML, ebXML, BizTalk and so on and middleware like Etricity, TIBCO, WebMethod and so on emphasize on how to interchange, what to interchange and the safety mechanisms, and have been widely used in the fields of finance and supply chain. These are generally called B2B integration techniques. Companies can interchange information such as orders for goods, stocks, invoices, production timing and so on through these techniques and platforms.

However, a sequential operation user environment is formed in each system of an enterprise after integration of EDI. The whole lifecycle data of product are distributed between different systems to cause difficult query. Moreover, in the business mode, much time for waiting information is wasted between the central manufacturers, providers and customers due to the operation way between systems, hence causing much inconvenience of the enterprise. Therefore, interchange for the whole lifecycle data between systems can no longer meet the requirement.

However, the above method only builds a fixed backbone between the finance, logistics and supply chain systems, and only performs simple operation-oriented information interchange between systems (e.g., order operation, stock operation, and so on). Furthermore, it only builds business relations between customer and enterprise and business relations between the ERP system and supply chain, can't flexibly make the smallest and quick deployment for different information environments, and can't perform information sharing, communication and management in each phase of the lifecycle of product.

Accordingly, the present invention aims to propose a method for integrating enterprise collaborative operations in the product lifecycle management and a system thereof to solve the above problems in the prior art.

### SUMMARY OF THE INVENTION

An object of the present invention is to provide a method for integrating enterprise collaborative operations in the product lifecycle management and a system thereof, which builds a system integration environment between customers, central manufacturers and providers to provide a collaborative cooperation platform between enterprises. Information can be interchanged in real time in the system integration environment in the whole product lifecycle management (PLM) from idea through requirement, design, development, manufacturing, planning and management, service after sale to termination, thereby accomplishing a system integration method and environment for providing collaborative management collaborative development, collaborative manufacturing, and collaborative marketing between enterprises, providers, and customers in the global environment.

To achieve the above object, the present invention provides a method for integrating enterprise collaborative operations in the product lifecycle management, wherein a system engineering service platform (SESP) is provided for integrating information systems inside enterprise. In the method, the information systems inside enterprise first finish preparation operations. Next, collaborative operation data generated by the information systems inside enterprise are compiled into a collaborative definition expression (CDE). The CDE is sent to a collaborative virtual machine (CVM) for syntax check, packaging and data encryption and to a SESP kernel (BASE) for interpretation and then to a collaborative operating services component (COSC) for processing. Finally, the processed information is sent to the CVM for check of the CDE. After interpretation and decryption of data, the information systems inside enterprise are called to perform subsequent operations.

The present invention also provides a preferred method for integrating enterprise collaborative operations in the product lifecycle management, wherein a system engineering service platform (SESP) is provided for integrating information systems outside enterprise. In the method, a client first makes a request to a CService. Next, the CService queries a service list or interface data and then sends out data required for the request or upload. The data required for the request or upload are then compiled into a CDE and then sent to an SESP kernel (BASE) after packaging and encryption. Subsequently, the SESP kernel (BASE) interprets the CDE and then sends to a COSC for processing according to the transmitted message. Finally, the processed result is packaged into a response of a service interface sent back to the client via CService.

The present invention also provides a preferred system for integrating enterprise collaborative operations in the product lifecycle management, wherein a SESP is provided. The SESP comprises at least a message server, at least a web server, a SESP server, at least a PLM application system server and an enterprise portal server. The message server is used for providing message-oriented transmission service on the SESP. The web server is used for providing web service on the SESP. The SESP server is connected with the message server and the web server and used for processing collaborative operations on the SESP. The PLM application system server is used to let central manufacturers or supply manufacturers connect the message server or the web server to enter the SESP for carrying out collaborative operations. The enterprise portal server is used to let a customer or another enterprise platform connect the message server or the web server to enter the SESP for carrying out collaborative operations.

In the above preferred system for integrating enterprise collaborative operations in the PLM, the SESP comprises an SESP kernel (BASE), a plurality of CVMs, a plurality of COSCs, a CService, a CGate, and a CInterface. The SESP kernel (BASE) is used as a basis of the SESP and a basic information processing kernel for basic logic operations. The CVMs are used to express collaborative operation actions through predefined collaborative operation dialog descriptions in accordance with different application systems of the client. The COSCs are used for providing basic collaborative operations services on the SESP and fast selecting appropriate modes and tools according to necessity to offer a quick and modular system integration environment. The CService is used for providing a foreign window of collaborative operation environment for the whole system and an interface or a window for global customers of the collaborative operation system or providers not joining in the system yet or information providers of other systems. The CGate is used for providing a communication gate between different collaborative operation systems or other platforms including an SESP of another collaborative operation system, common message-oriented middleware or public databases. The CInterface is used for providing a standard interface offering the function of self-defined configurations to meet requirements of different collaborative operation systems so that new operation components or enterprise expert systems can be developed according to the interface standard for different requirements.

The various objects and advantages of the present invention will be more readily understood from the following detailed description when read in conjunction with the appended drawings, in which:

### BRIEF DESCRIPTION OF THE DRAWINGS

FIG. 1 is a block diagram of a system environment of an existent enterprise;

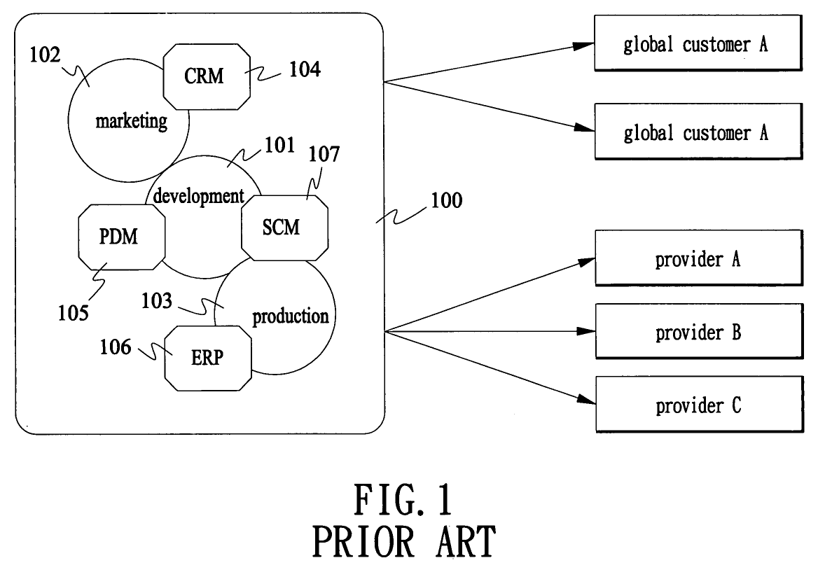

FIG. 2 is a block diagram of a system integration environment of the present invention;

FIG. 3 is a block diagram of a system network architecture of the present invention;

FIG. 4 is a block diagram of a software system architecture of the present invention;

FIG. 5 shows an SESP flowchart of the present invention for information systems inside enterprise; and

FIG. 6 shows an SESP flowchart of the present invention for information systems outside enterprise.

### DETAILED DESCRIPTION OF THE PREFERRED EMBODIMENTS

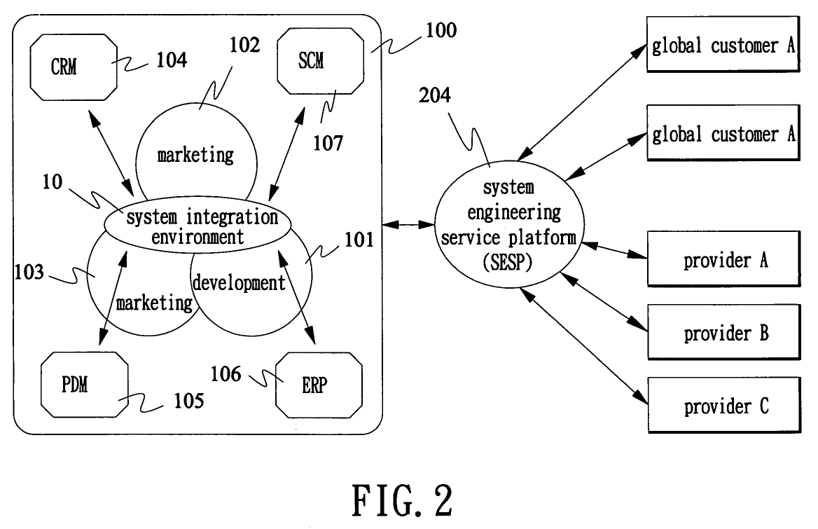

As shown in FIG. 2, the present invention mainly provide a method for integrating enterprise collaborative operations in the product lifecycle management (PLM) and a system thereof, which builds a system integration environment 204 between customers 200, central manufacturers and providers 202 to provide a collaborative cooperation platform between enterprises. Information can be interchanged in real time in the system integration environment in the whole PLM from product idea through requirement, design, development, manufacturing, planning and management, service after sale to termination, thereby accomplishing a system integration method and environment for providing collaborative management, collaborative development, collaborative manufacturing, and collaborative marketing between enterprises, providers, and customers in the global environment.

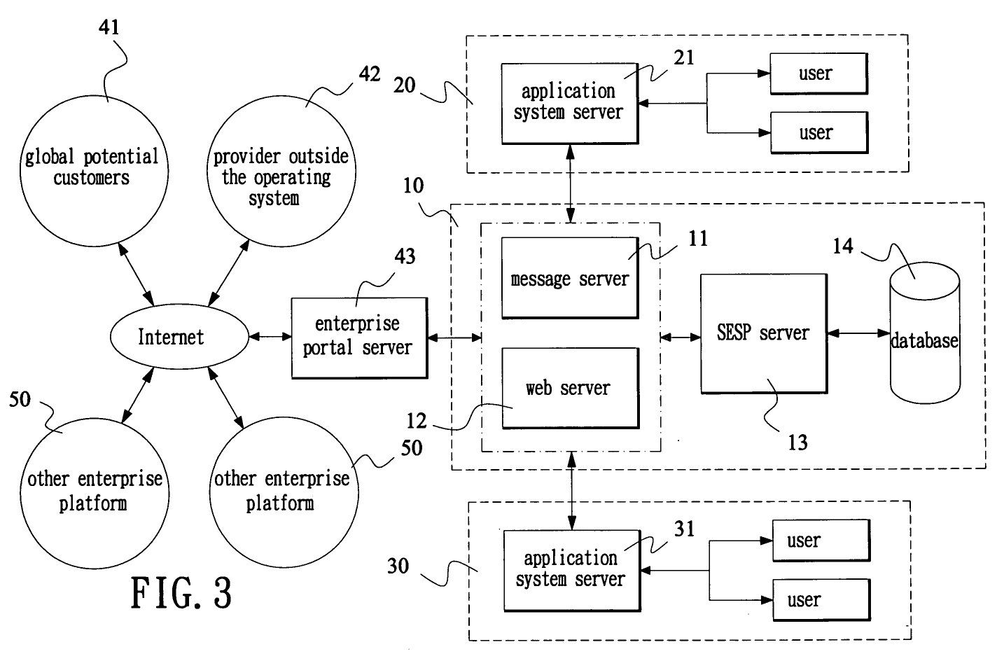

As shown in FIG. 3, the hardware network deployment of the present invention mainly comprises a system engineering service platform (SESP) 10, at least a central manufacturer 20, at least a supply manufacturer 30, a plurality of clients 40 and at least another enterprise platform 50. The SESP 10 is installed at the central manufacturer 20 or an information service provider having public credibility.

The SESP 10 comprises at least a message server 11, at least a web server 12 and a SESP server 13. The message server 11 is used for providing message-oriented transmission service on the SESP 10. The web server 12 is used for providing web service on the SESP 10. The SESP server 13 is connected with the message server 11 and the web server 12 and used for processing collaborative operations on the SESP 10. Relevant collaborative operation information can be stored in the SESP server 13 or another database server 14 in file format.

Users of the central manufacturer 20 and the supply manufacturer 30 can connect at least a PLM application system server 21 (or 31) via an intranet, and can connect the message server 11 or the web server 12 of the SESP 10 through a firewall and the Internet to enter the SESP 10 for performing collaborative operations. The PLM application system server 21 (or 31) can include CRM, PDM, ERP, SCM and so on.

The clients 40 comprise global potential customers 41 and providers 42 outside the operation system. The clients 40 can enter the SESP 10 via an enterprise portal server 43 through the Internet. The enterprise portal server 43 is installed outside the firewall of the SESP 10. Another enterprise platform 50 can register on the enterprise portal server 43 to connect the SESP 10.

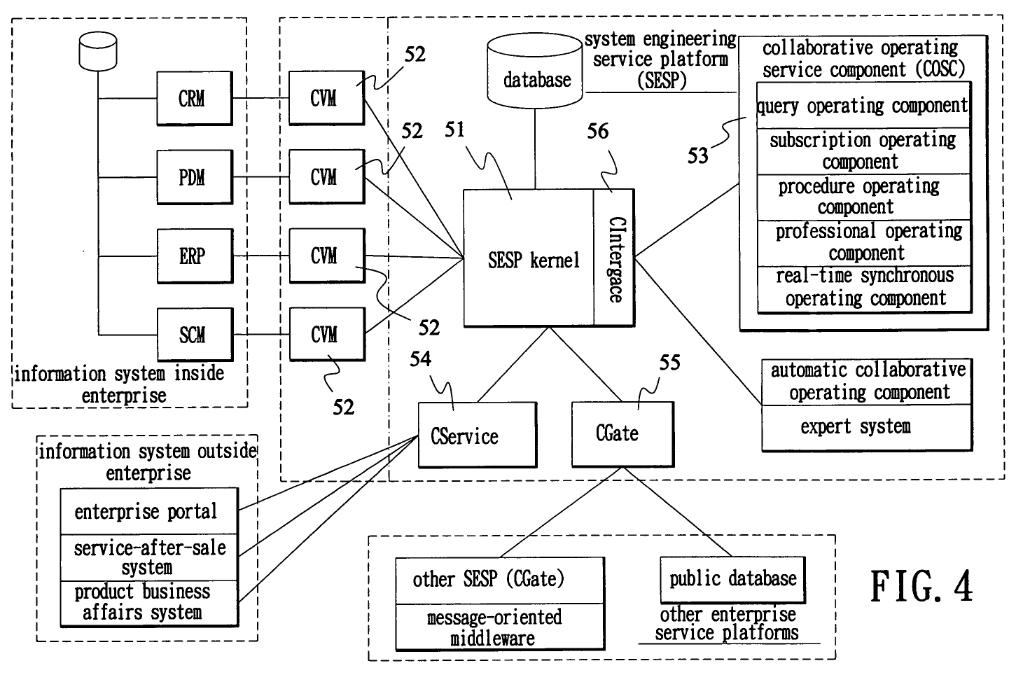

As shown in FIG. 4, the software system of the present invention is mainly used to build the SESP 10 as an environment kernel of collaborative operations between enterprises. The SESP 10 is composed of an SESP kernel (BASE) 51, a plurality of collaborative virtual machines (CVM) 52, a plurality of collaborative operating services components (COSC) 53, a CService 54, a CGate 55 and a CInterface 56.

The SESP kernel (BASE) 51 is a basis of the SESP 10, and is used as a basic information processing kernel for basic logic operations. The SESP kernel (BASE) 51 ought to have the following services:

1. A directory service including all service directories in collaboration operations. The directory contents include manufacturers' public key database, product classification, product serial numbers or manufacturers' serial numbers, and so on.

2. A routing service for sending messages to correct manufacturers or message receivers according to message transmission commands and performing subsequent processing to messages using the queue technique if the messages can't be promptly processed.

3. A registry service for providing registry service of product or manufacturer contents and message subscription service.

4. A repository service responsible for recording message transmission course, relevant message relationships and template definition of collaborative operation procedure.

5. A transaction service responsible for management of long-time transaction.

6. An authorization service for authorization of the environment system in the SESP 10 and identity validation.

The CVM 52 is a virtual machine technique for collaborative operations similar to Java. In order to correspond to virtual machines deployed on different platforms, clients corresponding to the SESP 10 may have different operating system (OS) environments or different application program systems. In existent integration methods, an adapter program for communication is written for two specific systems, hence having the disadvantages of time-consuming development and difficult maintenance.

In the present invention, in order to achieve the objects of the smallest customization and quick deployment, it is only necessary to choose different interfaces of the CVM 52 for different application systems of the clients according to different environments so as to express the actions of collaborative operations through predefined collaborative operation dialog descriptions. Therefore, the CVM 52 ought to have the following functions:

1. A packaging service responsible for packaging message packages and reading message packages.

2. A transferring service responsible for transmission of message packages.

3. An encryption service responsible for encryption/decryption of message packages.

4. A validation service responsible for interpreting and checking the syntax and meaning of message packages in the CDE.

The COSC 53 is obtained by the analysis and induction of all collaborative operation modes between today's enterprises. The COSC 53 is mainly used to provide basic collaborative operation services on the basic functions of the SESP kernel (BASE) 51 of the SESP 10. An enterprise can fast choose appropriate modes and tools according to necessity to offer a quick and modular system integration environment. Under the requirement of collaborative operations between enterprises, the basic operation modes may have the following five kinds of combination operations:

1. A message sending operation, which is a basic function of a message-oriented middleware for sending a packaged message from one terminal to another.

2. A query operation for performing a query action of a demanding terminal to another information provider.

3. A subscription/publication operation for subscription of information not issued yet or published periodically.

4. A collaborative procedure operation for integrating and expanding different procedures in enterprise into trans-enterprise procedures.

5. A real-time synchronous operation for providing real-time synchronous operation of basic messages, videos or audios and also integrating application systems inside enterprise (e.g., CAD/CAM) into a real-time synchronous operation.

The CService 54 is used as a foreign window for providing a collaborative operation environment for the whole system, and provides an interface or a window for global customers of the collaborative operation system or providers not joining in the system yet or information providers of other systems.

For the realization of the present invention, a web service interface can be built to have a corresponding CVM function internally. The web service interface also plays a role similar to the provider or central manufacturer for data circulation. Externally, the web service interface provides a message function issued externally in the collaborative operations of the enterprise system, and can integrate the portal website, the service-after-sale system or the product business affairs system, and so on of the enterprise system.

The CGate 55 is mainly used for providing a communication gate between different collaborative operation systems or other platforms including an SESP of another collaborative operation system, common message-oriented middleware or public databases.

The CInterface 56 is mainly used for providing a standard interface offering the function of self-defined configurations to meet requirements of different collaborative operation systems so that new operation components or enterprise expert systems like a video conference component, a chat room component or a knowledge management system, and so on of real-time collaborative operations can be developed according to the interface standard for different requirements.

Under the above system network architecture and software system architecture, an enterprise can define different collaborative operation modes according to different necessities to accomplish the demanded object through basic collaborative operation modes provided by these COSC 53.

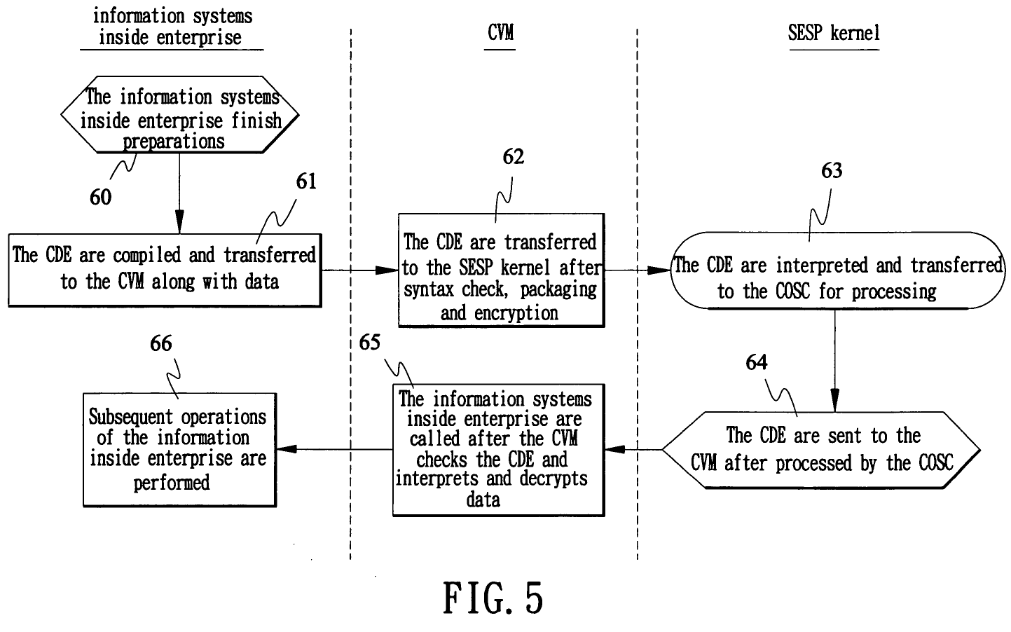

As shown in FIG. 5, in the system integration mode of the information systems inside enterprise and the SESP 10, different CVM 52 are chosen in accordance with operation environments and kinds of these different information systems inside enterprise. Moreover, the CDE are used for describing the operation actions and data of collaborative operations. The operation flowchart can be divided into a sending section and a receiving section.

In the sending section, after the information systems inside enterprise first finish preparations (Step 60), data such as collaborative operation type and action time, format and objective, and so on are compiled into CDE strings, which are transferred to the CVM 52 along with required media or file data for processing (Step 61) and then transferred to the SESP kernel (BASE) 51 after syntax check, packaging and encryption by the CVM 52 (Step 62). After the SESP kernel (BASE) 51 receives the information, the CDE are interpreted and transferred to the COSC 53 for processing (Step 63).

In the receiving section, information in the routing service queue are sent to the CVM 52 after processed by the COSC 53 (Step 64). The information systems inside enterprise are called after the CVM checks the CDE and interprets and decrypts data (Step 65). Subsequent operations of the information systems inside enterprise are performed (Step 66).

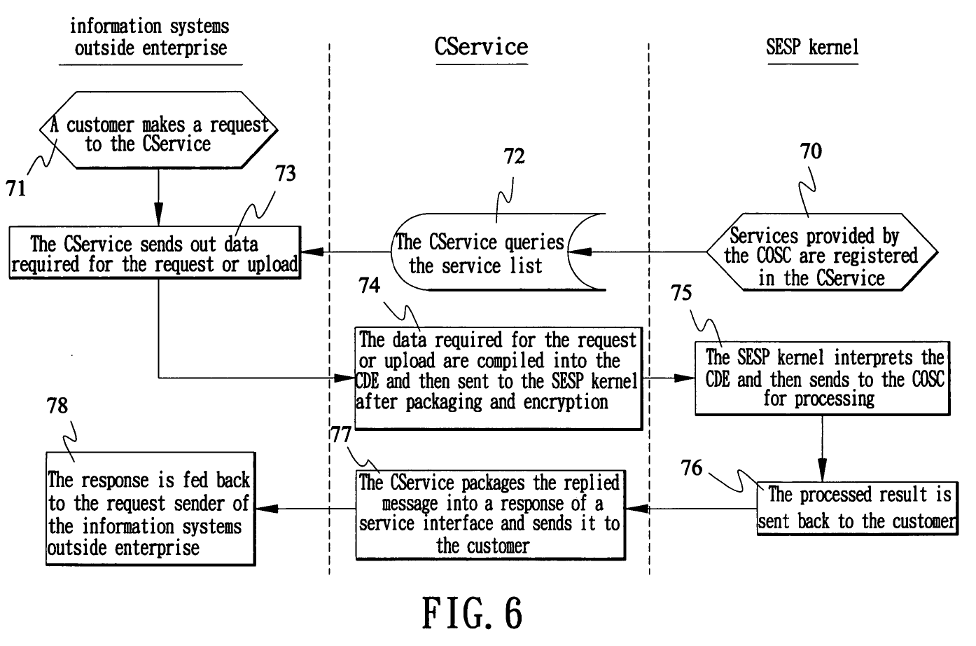

As shown in FIG. 6, the outside of enterprise in the present invention includes common clients and supply manufacturers outside the collaborative operation system. Different from the information systems inside enterprise, all clients outside enterprise enter the SESP 10 via a web portal system or an interface for providing services. Therefore, the system engineering operation procedure between the outside of enterprise and platform makes use of a request/response operation procedure.

It is necessary for the SESP kernel (BASE) 51 to first register services provided by the COSC 53 and services such as publication information issued by the central manufacturer 20 and supply manufacturer 30 into a service list or interface data of the CService 54 for integration (Step 70). Clients or supply manufacturers not joining the operation system yet can make a request to the CService 54 through a portal information system or directly for issued services (Step 71). The CService 54 queries the service list or interface data (Step 72) and then sends out data required for the request or upload (Step 73).

The data required for the request or upload are then compiled into the CDE by the CService 54 and then sent to the SESP kernel (BASE) 51 after packaging and encryption (Step 74). Subsequently, the SESP kernel (BASE) 51 interprets the CDE and then sends to the COSC 53 for processing according to the transmitted message (Step 75). Finally, the processed-result is sent back to the client via the CService 54 (Step 76).

The CService 54 packages the replied message into a response information of a service interface and sends it to the client (Step 77). The response information are received by the client and fed back to the information systems outside enterprise or fed back to the request sender by completely imitating a template page (Step 78).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method for integrating enterprise collaborative operations in product lifecycle management, a system engineering service platform being provided for integrating information systems inside enterprise, said method comprising the steps of:
a. compiling collaborative operating data generated by said information systems inside enterprise into a collaborative definition expression;
b. transferring said collaborative definition expression to a collaborative virtual machine for syntax check, packaging and data encryption;
c. transferring said collaborative definition expression to a system engineering service platform kernel and then to a collaborative operating services component after interpretation;
d. sending information processed by said collaborative operating services component to said collaborative virtual machine; and
e. calling said information systems inside enterprise after checking said collaborative definition expression and interpreting and decrypting data.

2. The method for integrating enterprise collaborative operations in product lifecycle management as claimed in claim 1, wherein said product lifecycle management includes the full product lifecycle from idea through requirement, design, development, manufacturing, planning and management, service after sale to termination.

3. The method for integrating enterprise collaborative operations in product lifecycle management as claimed in claim 1, wherein said information systems inside enterprise comprise information systems of a central manufacturer and at least a provider.

4. The method for integrating enterprise collaborative operations in product lifecycle management as claimed in claim 1 further comprising the step of finishing preparations of said information systems inside enterprise before said Step (a).

5. The method for integrating enterprise collaborative operations in product lifecycle management as claimed in claim 1, wherein said collaborative operation data in said Step (a) include collaborative operation types, action times, formats, and objects and media or file data.

6. The method for integrating enterprise collaborative operations in product lifecycle management as claimed in claim 1, wherein said collaborative virtual machine in said Step (b) expresses collaborative operation actions through predefined collaborative operation dialog descriptions in accordance with different application systems of said client.

7. The method for integrating enterprise collaborative operations in product lifecycle management as claimed in claim 1, wherein said system engineering service platform kernel in said Step (c) is a basis of said system engineering service platform, and is used as a basic information processing kernel for basic logic operations.

8. The method for integrating enterprise collaborative operations in product lifecycle management as claimed in claim 1, wherein said collaborative operating services component in said Step (c) provides basic collaborative operation services on said system engineering service platform, and can fast select appropriate modes and tools according to necessity to offer a quick and modular system integration environment.

9. The method for integrating enterprise collaborative operations in product lifecycle management as claimed in claim 1, wherein information are temporarily stored in a message queue of a routing service when said collaborative operating services component can't process them in real time, and are then sent to said collaborative virtual machine after processing in said Step (d).

10. The method for integrating enterprise collaborative operations in product lifecycle management as claimed in claim 1, wherein said information systems inside enterprise are called in said Step (e) to carry out subsequent operations.

11. A method for integrating enterprise collaborative operations in product lifecycle management, a system engineering service platform being provided for integrating information systems outside enterprise, said method comprising the steps of:
a. a client making a request to a CService;
b. said CService querying a service list or interface data and sending out data required for the request or upload;
c. compiling said data required for the request or upload into a collaborative definition expression and then sending to a system engineering service platform kernel after packaging and encryption;
d. said system engineering service platform kernel interpreting said collaborative definition expression and then sending to a collaborative operation services component for processing according to the transmitted message; and
e. packaging the processed result into a response of a service interface sent back to said client via said CService.

12. The method for integrating enterprise collaborative operations in product lifecycle management as claimed in claim 11, wherein said product lifecycle management includes the full product lifecycle from idea through requirement, design, development, manufacturing, planning and management, service to termination.

13. The method for integrating enterprise collaborative operations in product lifecycle management as claimed in claim 11, wherein said information systems outside enterprise comprise information systems of a plurality of clients or other enterprise platforms outside the collaborative operation system.

14. The method for integrating enterprise collaborative operations in product lifecycle management as claimed in claim 11 further comprising the step of registering the service provided by a collaborative operation services component in a service list or interface data of said CService before said Step (a).

15. The method for integrating enterprise collaborative operations in product lifecycle management as claimed in claim 11, wherein said CService in said Step (a) is a foreign window providing a collaborative operation environment for the whole system, and provides an interface or a window for global customers of the collaborative operation system or providers not joining in the system yet or information providers of other systems.

16. The method for integrating enterprise collaborative operations in product lifecycle management as claimed in claim 11, wherein said client makes a request to said CService via a portal information system in said Step (a).

17. The method for integrating enterprise collaborative operations in product lifecycle management as claimed in claim 11, wherein said system engineering service platform kernel in said Step (c) is a basis of said system engineering service platform, and is used as a basic information processing kernel for basic logic operations.

18. The method for integrating enterprise collaborative operations in product lifecycle management as claimed in claim 11, wherein said collaborative operating services component in said Step (d) provides basic collaborative operation services on said system engineering service platform, and can fast select appropriate modes and tools according to necessity to offer a quick and modular system integration environment.

19. The method for integrating enterprise collaborative operations in product lifecycle management as claimed in claim 11 further comprising the step of feeding back a response information of said service interface to said information systems outside enterprise or feeding back data to the request sender by completely imitating the template page after said Step (e).

20. A system for integrating enterprise collaborative operations in product lifecycle management, a system engineering service platform being provided for integrating information systems of a central manufacturer, at least a supply manufacturer, a plurality of clients or at least another enterprise platform, said system comprising:
at least a message server for providing message oriented transmission service on said system engineering service platform;
at least a web server for providing web service on said system engineering service platform;
a system engineering service platform server connected with said message server and said web server and used for processing collaborative operations on said system engineering service platform;
at least a product lifecycle management application system server installed at said central manufacturer or said supply manufacturer so that said central manufacturer or said supply manufacturer can connect said message server or said web server to carry out collaborative operations on said system engineering service platform; and
an enterprise portal server installed outside said system engineering service platform so that said client or another enterprise platform can connect said message server or said web server to carry out collaborative operations on said system engineering service platform.

21. The system for integrating enterprise collaborative operations in product lifecycle management as claimed in claim 20, wherein said product lifecycle management includes the full product lifecycle from idea through requirement, design, development, manufacturing, planning and management, service to termination.

22. The system for integrating enterprise collaborative operations in product lifecycle management as claimed in claim 20, wherein said system engineering service platform can be installed at said central manufacturer or information service providers having public credibility.

23. The system for integrating enterprise collaborative operations in product lifecycle management as claimed in claim 20, wherein relevant collaborative operation information processed by said system engineering service platform server can be stored in said system engineering service platform server or another database server in file format.

24. The system for integrating enterprise collaborative operations in product lifecycle management as claimed in claim 20, wherein said product lifecycle management application system server is connected to users of said central manufacturer and said supply manufacturer via an intranet and is connected to said message server or said web server through a firewall and the Internet.

25. The system for integrating enterprise collaborative operations in product lifecycle management as claimed in claim 20, wherein said system engineering service platform comprises:
a system engineering service platform kernel used as a basis of said system engineering service platform and a basic information processing kernel for basic logic operations;
a plurality of collaborative virtual machines used to express collaborative operation actions through predefined collaborative operation dialog descriptions in accordance with different application systems of said client;
a plurality of collaborative operating services components for providing basic collaborative operations services on said system engineering service platform and fast selecting appropriate modes and tools according to necessity to offer a quick and modular system integration environment;
a CService for providing a foreign window of collaborative operation environment for the whole system and an interface or a window for global customers of the collaborative operation system or providers not joining in the system yet or information providers of other systems;
a CGate for providing a communication gate between different collaborative operation systems or other platforms including system engineering service platforms of another collaborative operation systems, a message oriented middleware or public databases; and
a CInterface for providing a standard interface providing the function of self-defined configurations to meet requirements of different collaborative operation systems so that new operation components or enterprise expert systems can be developed according to the interface standard for different requirements.

26. The system for integrating enterprise collaborative operations in product lifecycle management as claimed in claim 25, wherein said system engineering service platform kernel further comprises:
a directory service including all service directories in collaboration operations, directory contents including manufacturers' public key database, product classification, product serial numbers or manufacturers' serial numbers;
a routing service sending messages to correct manufacturers or message receivers according to message transmission commands and performing subsequent processing to messages using the queue technique if the messages can't be promptly processed;
a registry service providing registry service of product or manufacturer contents and message subscription service;
a repository service responsible for recording message transmission course, relevant message relationships and template definition of collaborative operation procedure;
a transaction service responsible for management of long-time transaction; and
an authorization service for authorization of the environment system in said system engineering service platform and identity validation.

27. The system for integrating enterprise collaborative operations in product lifecycle management as claimed in claim 25, wherein said collaborative virtual machine further comprises:
a packaging service responsible for packaging message packages and reading message packages;
a transferring service responsible for transmission of message packages;
an encryption service responsible for encryption/decryption of message packages; and
a validation service responsible for interpreting and checking the syntax and meaning of message packages in said collaborative definition expression.

28. The system for integrating enterprise collaborative operations in product lifecycle management as claimed in claim 25, wherein said collaborative operating services component further comprises:
a message sending operation, which is a basic function of a message-oriented middleware for sending a packaged message from one terminal to another;
a query operation for performing a query action of a demanding terminal to another information provider;
a subscription/publication operation for subscription of information not issued yet or published periodically;
a collaborative procedure operation for integrating and expanding different procedures in enterprise into trans-enterprise procedures; and
a real-time synchronous operation for providing real-time synchronous operation of basic messages, videos or audios and also integrating application systems inside enterprise into real-time synchronous operation.

29. The system for integrating enterprise collaborative operations in product lifecycle management as claimed in claim 25, wherein said CService is used to build a web service interface corresponding to a collaborative virtual machine and used for providing the function of external messages in collaborative operations of the enterprise system.
